(19) United States
(12) Patent Application Publication
(10) Pub. No.: US 2016/0125757 A1
(43) Pub. Date: May 5, 2016

(54) OPERATOR SUPPORT SYSTEM, OPERATOR SUPPORT METHOD AND COMPONENT MOUNTING APPARATUS

(71) Applicant: Panasonic Intellectual Property Management Co., Ltd., Osaka (JP)

(72) Inventors: Yasuhiro MAENISHI, Yamanashi (JP); Nobuaki SAKAMOTO, Yamanashi (JP); Atsuto SHIMADA, Yamanashi (JP)

(21) Appl. No.: 14/861,137

(22) Filed: Sep. 22, 2015

(30) Foreign Application Priority Data
Oct. 30, 2014 (JP) 2014-221077

(51) Int. Cl. G09B 19/00; G05B 19/418; G09B 5/02

(52) U.S. Cl. CPC G09B 19/00; G09B 5/02; G05B 19/418; G05B 2219/45031

(57) ABSTRACT

An operator support system includes a controller which controls a component mounting apparatus. The controller includes: an input unit which receives an operator ID; a display unit which displays an operation instruction content or an operation learning content with respect to the operator; a memory unit which stores, in correspondence with the operator ID, an operator level and display history of the operation learning content; and an arithmetic processing unit which determines, at a time of executing an operation, the operation instruction content or the operation learning content to be displayed by the display unit, based on the operator ID input into the input unit, and the operator level and the display history corresponding to the input operator ID.

### CROSS-REFERENCES TO RELATED APPLICATION(S)

This application is based on and claims priority from Japanese Patent Application No. 2014-221077 filed on Oct. 30, 2014, the entire contents of which are incorporated herein by reference.

### BACKGROUND

1. Field of the Invention

One or more embodiments of the present invention relate to an operator support system and an operator support method, for supporting operation management and operation learning based on levels of respective operators in a component mounting apparatus for mounting electronic components on substrates, and also relates to the component mounting apparatus.

2. Description of Related Art

In a manufacturing field in which a predetermined operation is executed according to operator's operations of a facility equipment, an operation procedure to be performed by the operator at a time of executing the operation is displayed on a display means in a guidance format explained so that the operator can easily understand the procedure (see JP-A-2007-335711, for example). In the related art, an operation procedure permitted to be executed is limited depending on a level of each operator. That is, an operator of a low level is allowed to execute only limited operation contents, or is inhibited from executing the whole operation.

### SUMMARY

However, in the related art, as an operation of an operator of a low level is uniformly limited or inhibited, the following problem arises. That is, depending on a situation of a production site, an unskilled operator of a low level may be forcedly used in a production activity in a training shortage state so as to give the priority to the production activity. In such the case, as the execution of an operation by the operator of a low level is limited or inhibited frequently, the production is stopped until an operator of a high level executes the operation, and hence an operation rate of manufacturing facilities reduces. Further, in such the situation, the operator of a low level is limited on an opportunity of gaining operation experiences. As a result, as level-up of operation skill is delayed, entire workability cannot be improved sufficiently. In this manner, such the related art has a problem that, due to a level of an operator, it is difficult to improve the operation skill while preventing the reduction of the operation rate of manufacturing facilities.

One or more embodiments of the invention have been made in view of the above-described circumstances, an object thereof is to provide an operator support system, an operator support method and a component mounting apparatus each of which can improve a level of operation skill while preventing reduction of an operation rate of manufacturing facilities.

According to an aspect of the invention, there is provided an operator support system for supporting operation management and operation leaning for an operator who executes an operation with respect to a component mounting apparatus, the operator support system including: a controller which controls the component mounting apparatus, wherein the controller includes: an input unit which receives an input of an operator ID for identifying the operator; a display unit which displays an operation instruction content or an operation learning content with respect to the operator on a display device; a memory unit which stores, in correspondence with the operator ID, one of operator levels which are obtained by classifying the operator as a subject of the operation management into plural levels based on operator information of the operator, and display history of the operation learning content by the display unit; and an arithmetic processing unit which determines, at a time of executing the operation, the operation instruction content or the operation learning content to be displayed by the display unit, based on the operator ID input into the input unit, and the operator level and the display history of the operation learning content corresponding to the input operator ID.

According to another aspect of the invention, there is provided an operator support method for supporting operation management and operation leaning for the operator who executes an operation with respect to a component mounting apparatus, the operator support method including: inputting an operator ID for identifying the operator at a time of executing the operation; and displaying an operation instruction content or an operation learning content with respect to the operator, based on the input operator ID, and an operator level and display history of the operation learning content corresponding to the input operator ID.

According to yet another aspect of the invention, there is provided a component mounting apparatus for mounting an electronic component on a substrate, the component mounting apparatus including: a controller which controls the component mounting apparatus, wherein the controller includes: an input unit which receives an input of an operator ID for identifying the operator; a display unit which displays an operation instruction content or an operation learning content with respect to the operator on a display device; a memory unit which stores, in correspondence with the operator ID, one of operator levels which are obtained by classifying the operator as a subject of the operation management into plural levels based on operator information of the operator, and display history of the operation learning content by the display unit; and an arithmetic processing unit which determines, at a time of executing the operation, the operation instruction content or the operation learning content to be displayed by the display unit, based on the operator ID input into the input unit, and the operator level and the display history of the operation learning content corresponding to the input operator ID.

According to one or more embodiments of the invention, it is possible to improve a level of operation skill while preventing reduction of an operation rate of manufacturing facilities.

### BRIEF DESCRIPTION OF THE DRAWINGS

FIG. 1 is a diagram for explaining configuration of a component mounting system according to an embodiment of the invention;

FIG. 2 is a partial sectional diagram of component mounting apparatuses constituting the component mounting system according to the embodiment of the invention;

FIGS. 3A-3D are diagrams for explaining an example of a subject operation in an operator support system according to the embodiment of the invention;

FIG. 4 is a block diagram showing configuration of a control system of the component mounting apparatus constituting the component mounting system according to the embodiment of the invention;

FIGS. 5A and 5B are diagrams for explaining operator information and operator levels in the operator support system according to the embodiment of the invention;

FIGS. 6A and 6B are diagrams for explaining guide information and operation result information in the operator support system according to the embodiment of the invention;

FIG. 7 is a diagram showing a processing flow at a time of executing an operation by the component mounting apparatus in the operator support system according to the embodiment of the invention;

FIGS. 8A-8C are diagrams showing display screens in the operator support system according to the embodiment of the invention;

FIG. 9 is a diagram for explaining an update processing flow of an operator group in the operator support system according to the embodiment of the invention; and

FIG. 10 is a diagram for explaining a training guide learning flow in the operator support system according to the embodiment of the invention.

### DETAILED DESCRIPTION

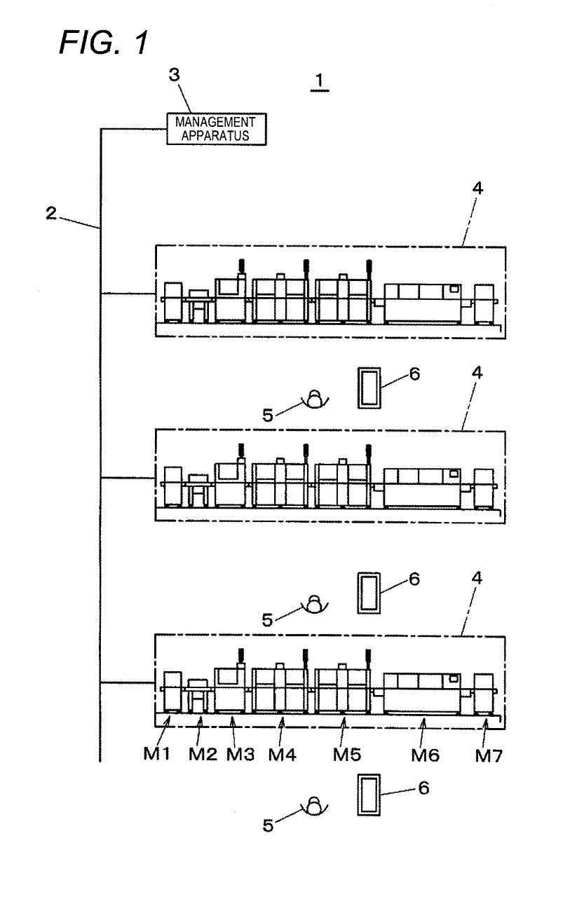

An embodiment according to the invention will be explained with reference to accompanying drawings. First, configuration of a component mounting system 1, to which an operator support system according to the embodiment is applied, will be explained with reference to FIG. 1. The component mounting system 1 has a function of mounting electronic components on substrates to thereby produce mounting substrates. In this embodiment, a plurality of component mounting lines 4 are connected to a management apparatus 3 via a communication network 2, and operators 5 assigned to the respective component mounting lines 4 perform various kinds of operations so as to operate the apparatuses. In this case, terminals 6 owned by the respective operators 5 are used as needed. Operations in the respective component mounting lines 4 are managed by the management apparatus 3. More specifically, the management apparatus 3 transmits data necessary for operating respective equipments belonging to the component mounting lines 4 to the respective equipments. Operation results of the respective equipments are transmitted to the management apparatus 3.

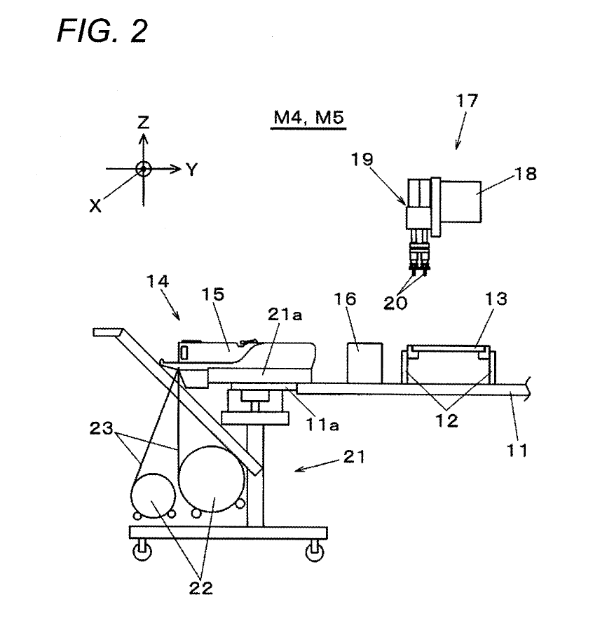

Each of the component mounting lines 4 is configured by serially coupling a substrate supply apparatus M1, a substrate delivery apparatus M2, a solder printing apparatus M3, component mounting apparatuses M4, M5, a reflow apparatus M6 and a substrate collection apparatus M7. A substrate 13 (see FIG. 2) supplied from the substrate supply apparatus M1 is transferred into the solder printing apparatus M3 via the substrate delivery apparatus M2. In the solder printing apparatus, the substrate 13 is subjected to a solder printing operation in which solder for joining components is screen-printed on the substrate 13.

The substrate 13 after the solder printing is transferred sequentially to the component mounting apparatuses M4 and M5, whereat the substrate 13 after the solder printing is subjected to a component mounting operation for mounting electronic components on the substrate. Then, the substrate 13 after the component mounting is transferred to the reflow apparatus M6, whereat the substrate is heated according to a predetermined heating profile and hence the solder for joining the components is molten and solidified. Thus, the electronic components are soldered to the substrate 13 and so a mounting substrate mounting the electronic components on the substrate 13 is completed. This mounting substrate is collected by the substrate collection apparatus M7.

FIG. 2 is a sectional diagram showing a main part of the component mounting apparatuses M4 and M5. In FIG. 2, a substrate transfer mechanism 12 is disposed along a substrate transfer direction (X direction; a direction perpendicular to a drawing sheet in this figure) on a base 11. The substrate transfer mechanism 12 transfers the substrate 13 carried therein from the solder printing apparatus M3 to position and hold the substrate at a position where a mounting operation is performed by a component mounting mechanism 17. The component mounting mechanism 17 is configured to horizontally move a mounting head 19, attached at its lower end with a suction nozzle 20, in X- and Y-directions by a head moving mechanism 18.

A component supply unit 14 is disposed at the side of the substrate transfer mechanism 12 in the Y direction (direction perpendicular to the X direction). A truck 21, in a state of being attached with a plurality of tape feeders 15 to a feeder base 21a in advance, is set to the component supply unit 14. A position of the truck 21 is fixed in the component supply unit 14 by clamping the feeder base 21a with respect to a fixed base 11a provided at the base 11. The truck 21 holds supply reels 22 which house, in a wound state, respective carrier tapes 23 each holding electronic components. The carrier tape 23 pulled out from the supply reel 22 is pitch fed by the tape feeder 15 to a component take-out position where a component is taken out by the suction nozzle 20.

A component recognition camera 16 is disposed between the component supply unit 14 and the substrate 13. When a mounting head 19, having taken out an electronic component from the carrier tape 23 by means of the suction nozzle 20, moves above the component recognition camera 16, the component recognition camera 16 images the electronic component in a state of being sucked and held by the suction nozzle 20.

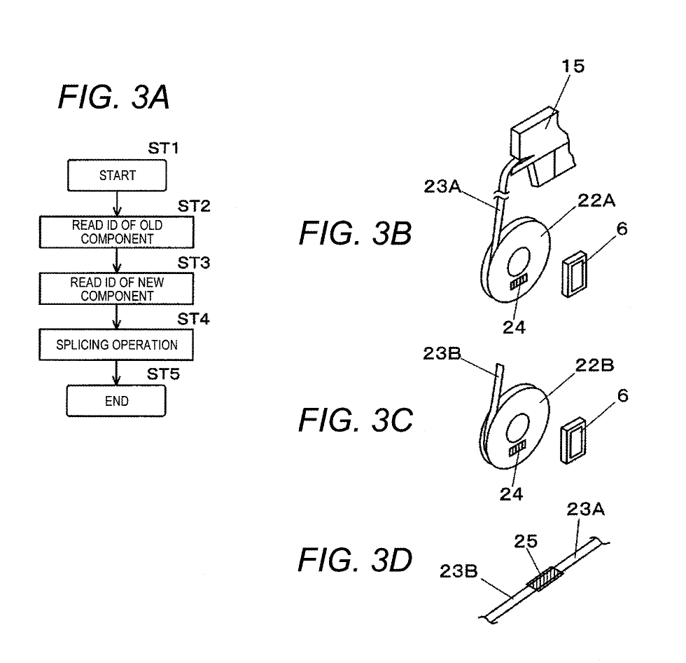

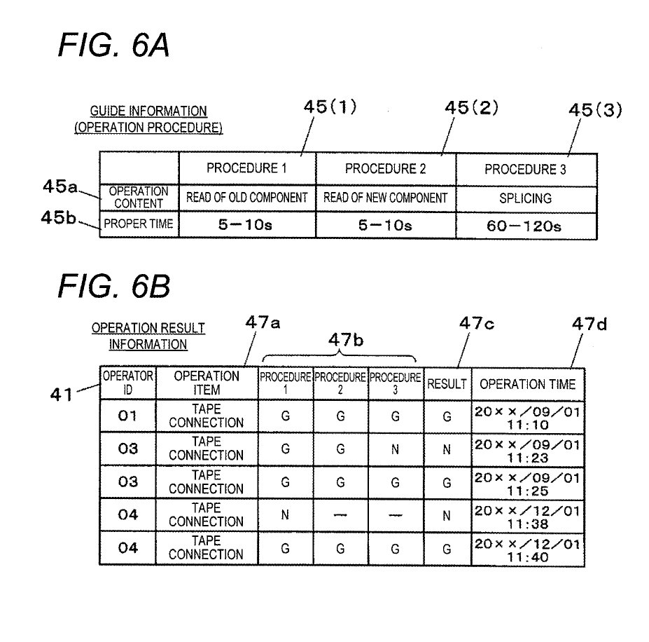

In the component mounting system 1, an operator 5 executes various kinds of operations with respect to the component mounting apparatuses M4 and M5. FIGS. 3A-3D show, among operations executed by the operator 5, an example of a tape connection operation (see also FIGS. 6A and 6B) which is executed in a case that component shortage occurs in the component supply unit 14 and so an exchange of the supply reel 22 is required. FIG. 3A is a processing flow of the tape connection operation and FIGS. 3B-D show a concrete procedure executed in this operation.

As shown in FIG. 3A, when the operation is started, firstly the operator 5 reads an ID of an old component (ST2). As shown in FIG. 3B, the operator reads a barcode 24 pasted to a supply reel 22A, which is in a state of winding and housing an already-mounted carrier tape 23A connected to the tape feeder 15 at this time and being set to the truck 21. That is, the operator reads a barcode 24 (ID of the old component) pasted to an old component reel using a barcode reading function of the mobile terminal 6. Next, the operator 5 reads an ID of a new component (ST3). As shown in FIG. 3C, the operator reads a barcode 24 (ID of the new component) pasted to a new supply reel 22B transferred for supplying components. That is, similarly, the operator reads a barcode pasted to a new component reel using the barcode reading function of the mobile terminal 6.

Then, the ID of the old component and the ID of the new component read in (ST2) and (ST3) are collated. In a case of coincidence of these IDs as a result of the collation, the new supply reel 22B is determined to be a correct supply reel 22 which supplies prescribed components to the tape feeder 15, and a splicing operation of the carrier tapes is executed (ST4). More specifically, as shown in FIG. 3D, an end portion of the carrier tape 23A and a start portion of a carrier tape 23B are abutted to each other and then coupled to each other by pasting a splicing tape 25 thereto.

In this case, the carrier tapes 23A and 23B are coupled in a state that an alignment of the carrier tapes 23A and 23B in the longitudinal direction thereof is adjusted and an interval of component pockets at the abutted portions of these tapes are adjusted. Thus, the tape connection operation is completed (ST5). By performing such the tape connection operation, components can be supplied without stopping the operation of the apparatuses.

In order to provide conditions for the operator 5 to accurately execute the tape connection operation in the component mounting apparatuses M4 and M5, it is required to prepare a system for suitably supporting operation management and operation learning of an operator 5. In this embodiment, such the support necessary for the operation management and the operation learning of operators is realized by an operator supporting system configured as explained below.

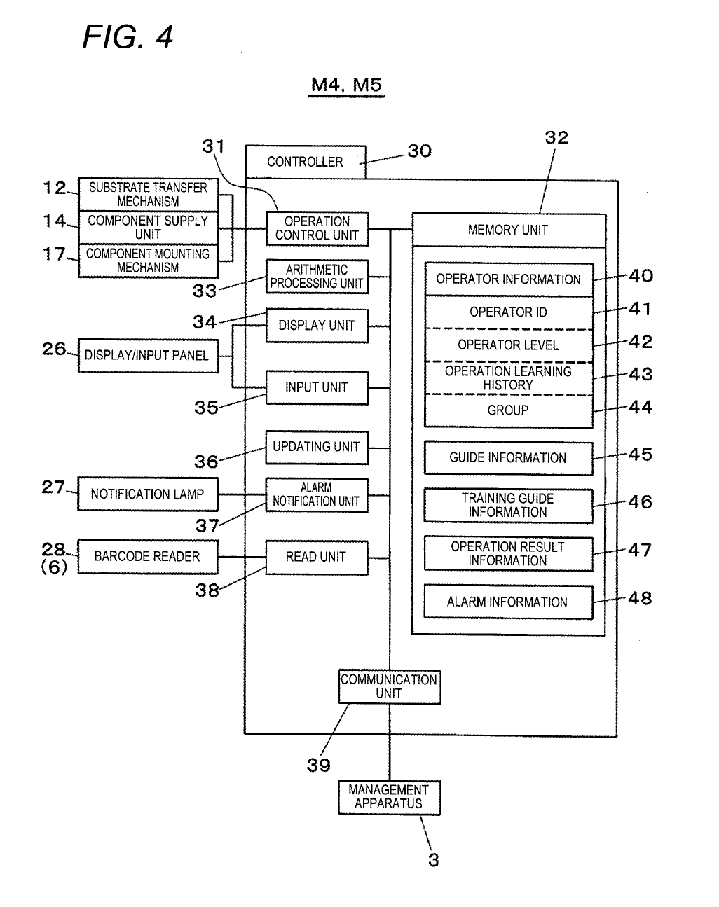

FIG. 4 shows constituent elements relating to the operator supporting system among the configuration of the component mounting apparatuses M4 and M5. In FIG. 4, a controller 30 includes an operation control unit 31, a memory unit 32, an arithmetic processing unit 33, a display unit 34, an input unit 35, an updating unit 36, an alarm notification unit 37, a read unit 38 and a communication unit 39.

The operation control unit 31 controls mechanical elements for executing the component mounting operation performed by the component mounting apparatuses M4 and M5, that is, the substrate transfer mechanism 12, the component supply unit 14 and the component mounting mechanism 17. The memory unit 32 stores various kinds of data used for supporting the operations as well as mounting data (not shown) used for control processing by the operation control unit 31. These data contains operator information 40, guide information 45, training guide information 46, operation result information 47 and alarm information 48.

The arithmetic processing unit 33 performs an arithmetic processing such as determination of screens (display contents) necessary for the operation support for respective operators 5, based on the data stored in the memory unit 32. Each of the display unit 34 and the input unit 35 is connected to a display/input panel 26. The display unit displays various kinds of screens (display contents), and the input unit receives data and instructions input by operators 5 via the display/input panel 26. The mobile terminals 6 owned by each of the operators 5 or a display/input panel of a touch panel type provided in each of the component mounting apparatuses M4, M5 and the management apparatus 3 is used as the display/input panel 26.

Data to be input contains operator IDs 41 for identifying respective operators 5. The input unit 35 inputs the operator IDs 41 for identifying the respective operators 5. Screens (contents) to be displayed contain operation instruction screens (an example of operation instruction contents) or operation learning screens (an example of operation learning contents) for respective operators 5. The display unit 34 displays the operation instruction screens or the operation learning screens for the respective operators 5 on the display/input panel 26 (an example of a display device). The updating unit 36 performs a processing of updating individual data stored for each of operators 5 in the memory unit 32. Subjects to be updated contain an operator level 42, an operation learning history (training guide learning history) 43 and a group 44 (group of learning history), as described later. The updating unit 36 individually updates the operator level 42 and the group of learning history.

The alarm notification unit 37 is connected to a notification lamp 27 such as a signal tower. The alarm notification unit 37 indicates, via the notification lamp 27, a required alarm when a predetermined event prescribed in advance as the alarm information 48 occurs. The read unit 38 performs a processing of reading an identification code (ID) such as a barcode 24 pasted on the supply reel 22, based on a signal from a barcode reader 28 provided at the mobile terminal 6. The communication unit 39 is a communication interface and performs transmission/reception of signals and data with the management apparatus 3 via the communication network 2.

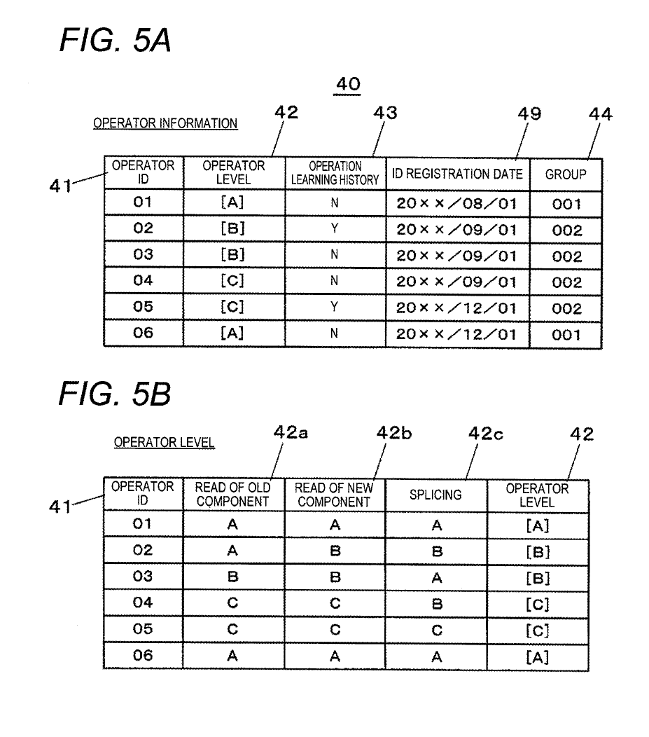

Next, explanation will be made as to data stored in the memory unit 32. First, the operator information 40 will be explained with reference to FIGS. 5A and 5B. As shown in FIG. 5A, the operator information 40 is configured to associate the operator level 42, the operation learning history 43, ID registration date 49 and the group 44 with each of the operator IDs 41 for identifying the respective operators 5. The operator levels 42 represent skill levels of operations performed by the respective operators 5. Concretely, the skill is classified into plural levels based on the occurrence number of times of operation error. An operator having a small occurrence number of times of the operation error is determined to belong to an operator level “A”, an operator having a middle occurrence number of times of the operation error is determined to belong to an operator level “B”, and an operator having a large occurrence number of times of the operation error is determined to belong to an operator level “C”.

FIG. 5B shows an example of grounds for determining the operator level 42. In this case, the skill is classified into the levels A to C for each of operation procedures constituting a particular operation item (the tape connection operation shown in FIGS. 3A-3D as an example). Then, the skill level is determined for each of the operation procedures with respect to each of the operators 5. Thereafter, the operator level 42 of the each operator is determined by totally considering the determination results. That is, in the example shown in FIG. 5B, the skill is determined to be one of the levels A to C for each of the operation procedures (“read of old component” 42a, “read of new component” 42b, “splicing” 42c) constituting the tape connection operation, with respect to each of the operators 5 identified by the respective operator IDs 41. Then, the operator level 42 (operator level “A”, operator level “B” or operator level “C”) is determined by totally considering the determination results.

The operation learning history 43 is a learning history representing whether or not the operator 5 learned a training guide, that is, a training for mastering the operation procedures so as to check or learn the operation procedures. A symbol “Y” is indicated for an operator already learned the training guide, and a symbol “N” is marked for an operator having not learned the training guide yet. The operation learning history 43 may be updated for each prescribed period with respect to a particular operator. For example, the updating to “a not-learned person” from “an already learned person” may be performed daily with respect to an operator 5 of the operator level “C”. The updating to “a not-learned person” from “an already learned person” may be performed weekly with respect to an operator 5 of the operator level “B”. The ID registration date 49 represents year, month and date on which the ID of the corresponding operator 5 is registered. The group 44 is set in the following manner in order to specify the operators 5 as subject persons of the operation learning using the respective mobile terminals 6

In this case, each of the operators 5 is classified into one of the groups of learning history depending on whether or not a particular operation learning screen is already displayed on the mobile terminal 6 of the each operator 5. That is, the operator 5 owning the mobile terminal 6 having already displayed the operation learning screen is classified as a group (001), whilst the operator 5 owning the mobile terminal 6 having not displayed the operation learning screen yet is classified as a group (002). In other words, the operator 5 owning the mobile terminal 6 corresponding to the group (001) is not necessary for taking the operation learning, whilst the operator 5 owning the mobile terminal 6 corresponding to the group (002) is necessary for taking the operation learning.

In the operator information 40, there is no direct relation among the operator level 42, the group 44 and the operation learning history 43. The classification of the operation learning history 43 may differ among the operators 5 of the same operator level 42. Also, the classification of the group 44 may differ among the operators 5 of the same operation learning history 43. In this embodiment, the operation learning screen is displayed on the mobile terminal 6 of the operator 5 who belongs to the group 44 (group of learning history) having not displayed the particular operation learning screen yet or the mobile terminal of the operator 5 whose operator level 42 is low.

Determination of the screens containing the operation instruction screens and the operation learning screens is performed by the arithmetic processing unit 33. That is, the arithmetic processing unit 33 performs, at a time of executing the operation, a processing of determining the operation instruction screen or the operation learning screen to be displayed by the display unit 34, based on the operator ID 41 input into the input unit 35, the operator level 42 corresponding to this operator ID 41 and the history (operation learning history 43) concerning the display of the operation learning screen.

In the configuration of the controller 30, the memory unit 32 stores, in correspondence with the respective operator IDs 41, the operator levels 42 which are obtained by classifying the operators 5 as subjects of the operation management into the plural levels based on the operator information 40 of the operators 5, and the histories concerning the display of the training guide screen for the operation learning by the display unit 34. The data to be stored in the memory unit 32 is read via the communication network 2 from a memory unit of the management apparatus 3 as a host apparatus.

Next, an example of the guide information 45 for instructing operation contents etc. to an operator will be explained with reference to FIG. 6A. In this example, the “tape connection” exemplified in FIGS. 3A-3D is a subject operation item. Operation contents 45a contains guide information 45(1) to guide information 45(3) described as operation procedures for suitably executing this operation item. In this example, “read of old component”, “read of new component” and “splicing” shown in FIG. 3A are raised as the operation contents 45a of the guide information 45(1) to guide information 45(3) in the “tape connection”.

Respective proper times 45b in a case of executing the operation contents 45a are described in correspondence to the guide information 45(1) to guide information 45(3). Each of the proper times 45b shows a range of a required time permitted for a normal operator 5 at a time of executing the corresponding operation. Each of the respective operators 5 executes the corresponding operations based on the proper times 45b as target times. By displaying the guide information 45 thus configured, each of the operators 5 can check information for executing the operation item to be executed according to the correct operation procedure at the time of executing the operation. The controller 30 determines whether or not the operation procedure actually executed by the operator 5 is correct, with reference to the operation procedure shown in the guide information 45.

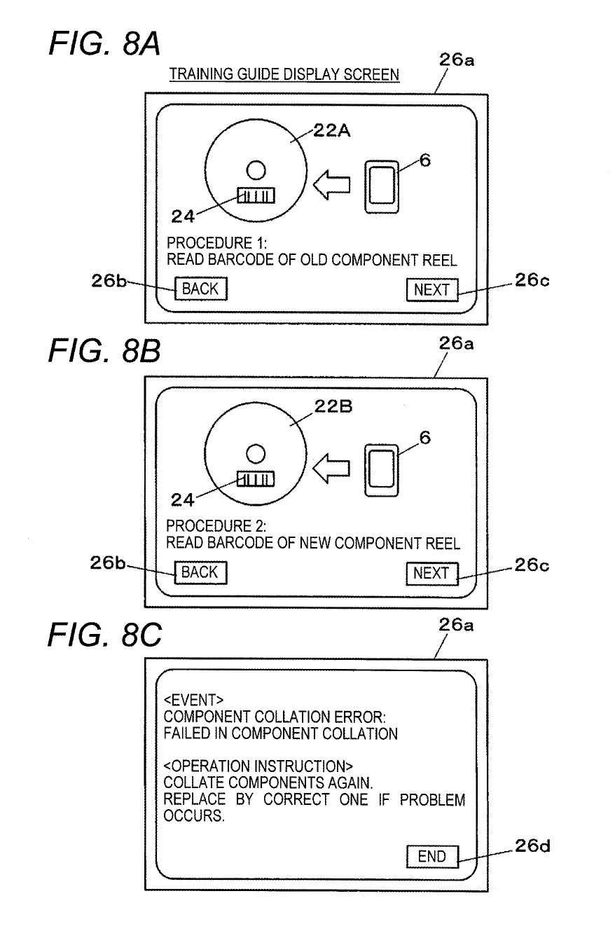

The training guide information 46 is information for displaying screens for the operation learning of operators. The guide information 45 is support information which is prepared for operators 5 each having some operation experience and an operator level of an intermediate degree (operator level “B”, for example) or more. In contrast, the training guide information 46 is support information which is prepared for unskilled operators 5 each having, for example, the operator level “C”. Thus, the training guide information 46 has a screen configuration representing the contents visually to the utmost so that such the operators can easily understand and recognize the learning contents (see a training display screens shown in FIGS. 8A-8C).

Next, an example of the operation result information 47 will be explained with reference to FIG. 6B. The operation result information 47 is data representing results of the operations executed by the operators 5 with respect to the component mounting apparatuses M4, M5. The operation result information 47 is transmitted to the management apparatus 3 via the communication unit 39. The management apparatus 3 determines whether or not each of the operation results is proper. In this case, the “tape connection” shown in FIGS. 3A-3D is also exemplified as an operation item 47a. The operation result information shows, in a table format, respective operations and operation results executed by the five operators 5 having the operator IDs 01 to 05 as the operator information 40.

That is, the operation results, in a case where each of the operators 5 executes the procedures 1 to the procedure 3 (“read of old component”, “read of new component” and “splicing” shown in FIG. 6A) shown in procedures 47b, is represented in a determination format of good “G” or not good “N”. Result 47c represents total evaluation and determination results of the operation results of the procedures 1 to the procedure 3 for each of the operators, similarly in a total determination format of good “G” or not good “N”. Further, operation time 47d stores year, month, date and time at which this operation is actually executed with respect to each operator, as time history data.

The operation result information 47 is prepared based on information input from the display/input panel 26 and a barcode reader 28 provided in each of the component mounting apparatuses M4, M5. As to an operation to be executed without using the display/input panel 26 or the barcode reader 28, an operation complete button and an operation interrupt button are displayed on the display/input panel 26 during the execution of this operation. The operator 5 pushes the operation complete button of the display/input panel 26 at the time of completing the operation, whereby the controller 30 determines that the operation to be executed without using the display/input panel 26 or the barcode reader 28 is completed. In a case where an operator determines by one self that the operation cannot be completed, the operator pushes the operation interrupt button, whereby the controller 30 determines that the operation to be executed without using the display/input panel 26 or the barcode reader 28 is interrupted (or operation error occurs).

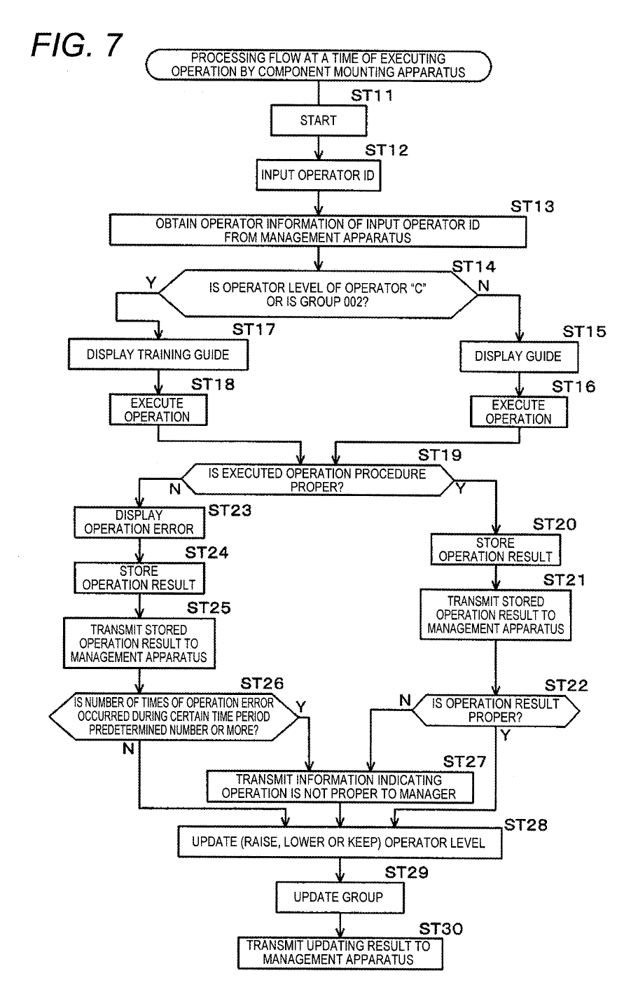

Next, a processing flow executed by the controller 30 at the time of executing the operation by the component mounting apparatuses M4, M5 will be explained with reference to FIG. 7. When the processing is started (ST11), an operator 5 operates the mobile terminal 6 to input the operator ID 41 of the operator who executes the operation (ST12). The operator ID 41 thus input is transmitted to the management apparatus 3. The controller 30 obtains the operator information 40 of the operator 5 corresponding to the operator ID 41 thus input from the management apparatus 3 (ST13).

Next, determination is made whether or not the operator 5 has qualification to execute the operation. If it is determined that the operator 5 having no qualification to execute the operation accesses the apparatus, the controller 30 performs a locking operation of inhibiting the operation of this operator 5 and controls the alarm notification unit 37 so that the notification lamp 27 indicates this fact as an alarm.

Next, the operator level is checked with respect to the operator 5 having qualification to execute the operation. In this example, determination is made whether or not the operator level of this operator 5 is the operator level “C” or whether or not the group of this operator 5 is (002) (ST14). If the operator does not satisfy any of these conditions of (ST14), the display unit 34 displays the guide for instructing the operation to be executed (ST15). Then, the operator 5 executes the operation according to the displayed guide (ST16).

In (ST14), if it is determined that the operator level of this operator 5 is not the operator level “C”, and that the group of this operator 5 is (002) and the skill level of this operator 5 is low, the training guide is displayed (ST17). That is, in this case, a procedure of checking the operation procedure or learning the operation contents is displayed. For example, FIG. 8A shows a training guide screen corresponding to the procedure 1 (read of old component), in which a display screen 26a of the display/input panel 26 displays an instruction screen instructing to read by the mobile terminal 6 the barcode 24 of the supply reel 22A provided with the already-mounted carrier tape. Then, when a “back” button 26b or a “next” button 26c is operated, the screen displayed on the display screen 26a shifts to a corresponding screen.

FIG. 8B shows a training guide screen corresponding to the procedure 2 (read of new component), in which the display screen 26a displays an instruction screen instructing to read the barcode 24 of the new supply reel 22B by the mobile terminal 6. Then, similarly, when the “back” button 26b or the “next” button 26c is operated, the screen displayed on the display screen 26a shifts to a corresponding screen. That is, the unskilled operator 5 having a low operator level executes the operation with reference to the training guide displayed in this manner (ST18).

When the operations are executed in (ST16) or (ST18), the controller 30 determines whether or not the procedures of the operations thus executed are proper (ST19). When determination is made that the operation procedures is proper, the controller 30 stores the operation result in the memory unit 32 as the operation result information 47 (ST20), and transmits the operation result thus stored to the management apparatus 3 via the communication unit 39 (ST21). Then, the management apparatus 3 determines whether or not the operation result thus transmitted is proper (ST22).

In contrast, when determination is made in (ST19) that the method or procedure of the operations is not proper, the display unit 34 displays that an operation error occurs (ST23). FIG. 8C shows an example of such the display of the operation error. The display screen 26a displays a component collation error as a <event> considered to be an operation error. As an <operation instruction> with respect to this <event>, it is requested to collate the components again and to replace by a correct component if there arises a problem. This display is terminated by operating an end button 26d. The operation error contains a case that the method and procedure of the operation is proper but the respective procedures are not completed within the proper times.

After displaying the operation error in (ST23), the controller 30 stores operation result in the memory unit 32 as the operation result information 47 in the similar manner (ST24), and transmits the operation result thus stored to the management apparatus 3 via the communication unit 39 (ST25). Then, the management apparatus 3 determines based on the operation results thus transmitted whether or not the number of times of the operation error occurred during a certain time period is a predetermined number or more (ST26).

Next, when the determination is made that the operation result is not proper in (ST22) or the number of occurrence times of the operation error is the predetermined number or more in (ST26), the controller 30 transmits in each case to a manager the determination result that the operation is not proper (ST27). Thereafter, the updating unit 36 updates the operator level based on the determination result (ST28). In this example, the operator level is raised, lowered or kept based on an updating criterion set in advance according to the contents of the determination results.

For example, when the determination is made that the operation result is proper in (ST22) or the number of occurrence times of the operation error is less than the predetermined number in (ST26), the operator level is raised or kept in (ST28). In contrast, in a case where the determination result that the operation executed by the operator is not proper is transmitted in (ST27), the operator level is lowered in (ST28).

Next, the group is updated (ST29), and this updating result is transmitted together with the updating result of the operator level in (ST28) to the management apparatus 3 (ST30). Thus, the corresponding operator level 42 and group 44 contained in the operator information 40 stored in the management apparatus 3 are updated. The operator level 42 and group 44 thus updated are read into the component mounting apparatuses M4, M5 in the next operation procedure. In a case where the operation error is displayed in (ST23), as this operation has not been completed yet, the processing returns to (ST11). Alternatively, the processing may return to (ST14) by omitting the operator ID inputting process (ST12) so that the same operator executes the processing of this operation again.

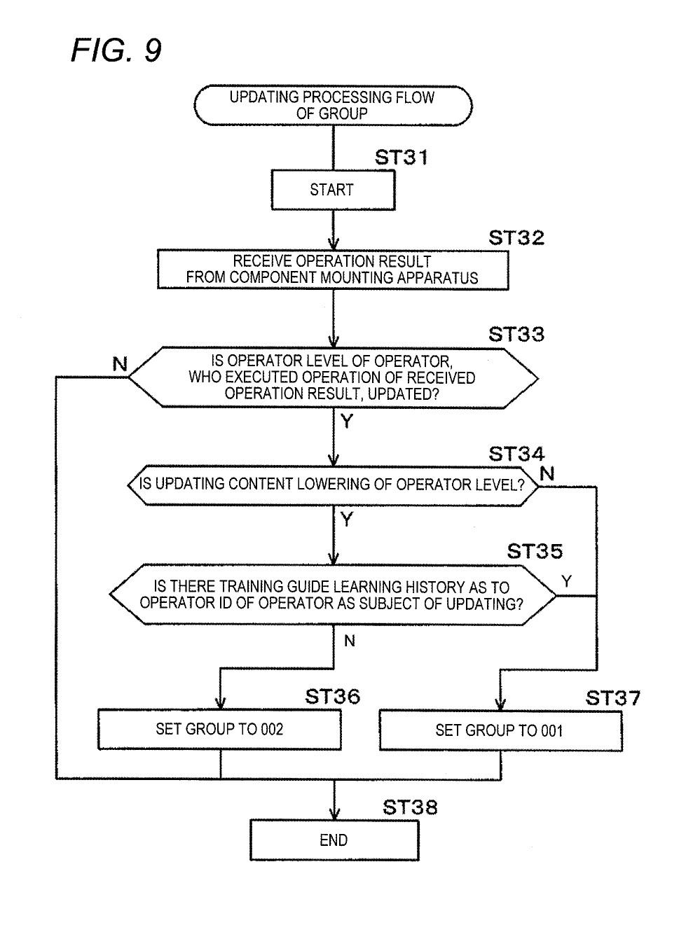

Next, the group updating processing in (ST29) will be explained with reference to FIG. 9. When this processing starts (ST31), the controller 30 receives the operation result from the component mounting apparatuses M4, M5 (ST32). Then, determination is made whether or not an operator level of the operator 5, who executed the operation of the received operation result, is updated (ST33). In a case where the operator level is not updated, the processing shifts to an end (ST38) to terminate the processing. In a case where the operator level is updated in (ST33), determination is made whether or not the updating content is the lowering of the operator level (ST34).

In a case where the updating content is not the lowering of the operator level, the processing shifts to (ST37) to thereby set the corresponding group to (001). In a case where the operator level is lowered in (ST34), determination is made whether or not there is a learned history of the training guide as to the operator ID41 of this operator 5 as a subject of the updating, based on the operation learning history 43 (ST35). When the determination is made that there is the learned history of the training guide, the processing shifts to (ST37) to thereby set the corresponding group to (001).

When the determination is made that there is not the learned history of the training guide in (ST35), the processing shifts to (ST36) to thereby set the corresponding group to (002). Then, learning of the training guide is implemented with respect to the operator 5 owning the mobile terminal 6 whose group is set to (002).

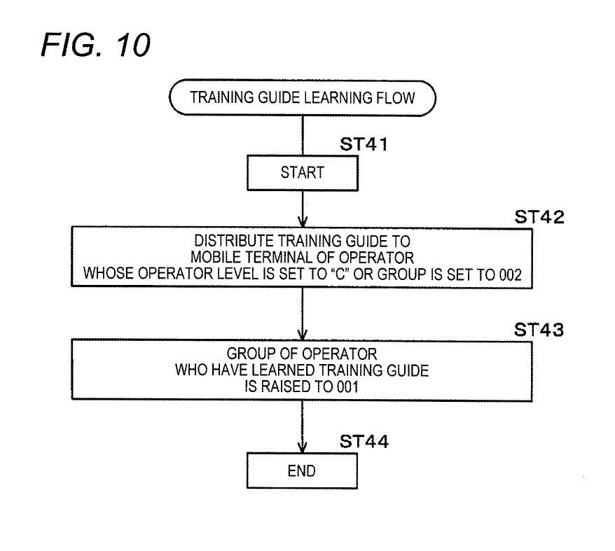

Next, the training guide learning will be explained with reference to FIG. 10. In the component mounting system 1 shown in this embodiment, each of the operators 5 owns the mobile terminal 6 having the input/display function. Learning of the training guide is performed by distributing the training guide to the mobile terminal 6 owned by the operator 5 who is specified as a subject to be learned.

More specifically, when a processing flow of the learning starts (ST41), the management apparatus 3 or the controller 30 distributes the training guide as a subject to be learned to the mobile terminal 6 of an operator 5 whose operator level is set to “C” or group is set to (002) (ST42). In response to this distribution, the subject operator 5 looks and reads a learning screen displayed on the screen of the mobile terminal 6 and learns predetermined contents. Next, when the management apparatus 3 or the controller 30 receives a response indicating termination of the learning from this operator 5, the termination of learning is admitted. Then, based on the admission of the termination of learning, the group 44 of the operator 5 thus learned the training guide is raised to (001) (ST43).

In this manner, by automatically causing an operator 5 to learn the training guide via the mobile terminal 6, an operator 5 required to learn can be timely caused to learn necessary learning contents. By doing so, loss of a learning opportunity, caused by missing an actual execution opportunity of an operation because of an unskilled person with less experience, is compensated, and operators are always given opportunity of improving the skill. Incidentally, although the aforesaid distribution of training guide may be performed any time, it is desirable to distribute the data after confirming that a subject operator is in the outside of working hours, for example, before starting the work, after ending the work, or rest during the working hours.

As explained above, in the operation support system according to the embodiment, the operator levels 42 obtained by classifying operators as subjects of the operation management based on the operator information 40 are stored together with the histories concerning the display of the operation learning screen by the display unit 34, in correspondence with the respective operator IDs 41. Then, the operation instruction screen or the operation learning screen to be displayed on the display unit 34 is determined based on the operator ID 41 input in the input unit 35 at a time executing the operation, the operator level 42 corresponding to this operator ID 41 and the corresponding history concerning the display of the operation learning screen.

Accordingly, decrease in the operation rate of manufacturing facilities can be prevented by suppressing an operation error occurred when an unskilled operator having a low operation skill level executes the operation. Further, the operation skill level can be improved by securing opportunity of the operation learning for the unskilled operator. The invention is explained above referring to the embodiment. It will be understood by those skilled in the art that the embodiment is an example, and the invention contains various modifications in the combination of the constituent elements and the processing processes and such the modifications are within a scope of the invention.

Although the aforesaid embodiment shows a case that the input unit 35 is connected to the display/input panel 26, the input unit is not limited thereto so long as it can receive input of the operator information. For example, an identification unit such as a card reader or a bar code reader capable of identifying the operator ID 41 may be used as the input unit.

Each of the operator support system, the operator support method and the component mounting apparatus according to one or more embodiments of the invention can provide effect that a skill level of operation can be improved while preventing decrease in the operation rate of manufacturing facilities, and each of them is useful in a component mounting field for counting components on substrates.

What is claimed is:

1. An operator support system for supporting operation management and operation leaning for an operator who executes an operation with respect to a component mounting apparatus, said operator support system comprising:
a controller which controls the component mounting apparatus,
wherein the controller comprises:
an input unit which receives an input of an operator ID for identifying the operator;
a display unit which displays an operation instruction content or an operation learning content with respect to the operator on a display device;
a memory unit which stores, in correspondence with the operator ID, one of operator levels which are obtained by classifying the operator as a subject of the operation management into plural levels based on operator information of the operator, and display history of the operation learning content by the display unit; and
an arithmetic processing unit which determines, at a time of executing the operation, the operation instruction content or the operation learning content to be displayed by the display unit, based on the operator ID input into the input unit, and the operator level and the display history of the operation learning content corresponding to the input operator ID.

2. The operator support system according to claim 1, further comprising:
a management apparatus which manages the component mounting apparatus,
wherein the controller determines whether or not an operation procedure of the operation executed by the operator is proper, and
wherein the management apparatus determines whether or not operation result of the executed operation is proper.

3. The operator support system according to claim 1, further comprising:
a mobile terminal,
wherein the operator is classified into one of learning history groups depending on whether or not the operation learning content is already displayed on the mobile terminal of the operator, and
wherein a particular operation learning content is displayed on the mobile terminal of the operator who belongs to the learning history group which indicates that the operator has not displayed the particular operation learning content yet, or whose operator level is low.

4. The operator support system according to claim 1,
wherein the controller further comprises:
an updating unit which individually updates the operator level and the learning history group for the operator.

5. An operator support method for supporting operation management and operation leaning for the operator who executes an operation with respect to a component mounting apparatus, said operator support method comprising:
inputting an operator ID for identifying the operator at a time of executing the operation; and
displaying an operation instruction content or an operation learning content with respect to the operator, based on the input operator ID, and an operator level and display history of the operation learning content corresponding to the input operator ID.

6. A component mounting apparatus for mounting an electronic component on a substrate, said component mounting apparatus comprising:
a controller which controls the component mounting apparatus,
wherein the controller comprises:
an input unit which receives an input of an operator ID for identifying the operator;
a display unit which displays an operation instruction content or an operation learning content with respect to the operator on a display device;
a memory unit which stores, in correspondence with the operator ID, one of operator levels which are obtained by classifying the operator as a subject of the operation management into plural levels based on operator information of the operator, and display history of the operation learning content by the display unit; and
an arithmetic processing unit which determines, at a time of executing the operation, the operation instruction content or the operation learning content to be displayed by the display unit, based on the operator ID input into the input unit, and the operator level and the display history of the operation learning content corresponding to the input operator ID.
